(19) United States
(12) Patent Application Publication
(10) Pub. No.: US 2017/0235677 A1
(43) Pub. Date: Aug. 17, 2017

(54) COMPUTER SYSTEM AND STORAGE DEVICE

(71) Applicant: Hitachi, Ltd., Tokyo (JP)

(72) Inventors: Hidenori SAKANIWA, Tokyo (JP); Wataru OKADA, Tokyo (JP); Yoshinori OHIRA, Tokyo (JP); Etsutarou AKAGAWA, Tokyo (JP); Nobuhiro MAKI, Tokyo (JP); Mioko MORIGUCHI, Tokyo (JP)

(73) Assignee: Hitach, Ltd., Tokyo (JP)

(21) Appl. No.: 15/502,636

(22) PCT Filed: Nov. 12, 2014
(86) PCT No.: PCT/JP2014/079986

§ 371 Date: Feb. 8, 2017

(51) Int. Cl. G06F 12/0895; G06F 12/0806

(52) U.S. Cl. CPC G06F 12/0895; G06F 12/0806; G06F 2212/62; G06F 2212/604; G06F 2212/1016; G06F 2212/1032; G06F 2212/154

(57) ABSTRACT

A computer system that is composed of a host computer, a storage device and a management computer. The storage device comprises a port for connecting with the host computer, a cache memory, a processor, and a plurality of logic volumes which are logical memory regions. For each logic volume, the port, the cache memory and the processor are divided into logic partitions, as resources that are used for reading and writing in the logic volume. The host computer reads and writes with respect to the logic volumes. If a failure occurs in the storage device, the management computer issues a command to the storage device to allocate the resources of a logic partition for which reading/writing performance is not ensured to a logic partition for which reading/writing performance is ensured.

### TECHNICAL FIELD

The present invention relates to a computer system and a storage device.

### BACKGROUND ART

As the consolidation of storage devices progresses, a multi-tenant type use form in which a plurality of companies or a plurality of departments share a single storage device has increased in data centers or the like. At the same time, with the increase in the size and complexity of storage devices, it becomes difficult to manage all storage devices by a limited number of people. For this situation, a technique capable of dividing one storage device into a plurality of logical partitions and managing each logical partition individually is known. In this case, when an administrator of the entire storage device creates logical partitions and allocates the logical partition to each company or each department, it is possible to delegate a storage device management task and distribute a management load.

In regard to the technique of dividing such a storage device into a plurality of logical partitions, for example, Patent Document 1 states “when a logical partitioning technique is simply applied to a cluster type storage system, it is difficult to form a logical partition across clusters and guarantee a logical partition of performance according to an allocated resource amount. . . . Resources in a first cluster are allocated to one logical partition. . . . Further, when a failure occurs in the first cluster, a second cluster may be configured to continue a process of the first cluster.”

### CITATION LIST

### Patent Document

Patent Document 1: US 2009/0307419 A

### SUMMARY OF INVENTION

### Technical Problem

According to the disclosure of Patent Document 1, performance according to the allocated resource amount is guaranteed. However, when a failure occurs in the first cluster, the second cluster has not necessarily a resource amount sufficient to guarantee performance.

In enterprise environments, in general, a technique of guaranteeing performance of logical partitions is employed, and in an environment in which there are a plurality of logical partitions in one storage device in a cloud environment, there is a situation in which logical partitions that should guarantee performance even at the time of failure and logical partitions which are forced to perform a degenerated operation are mixed.

In this regard, it is an object of the present invention to rearrange limited resources in a logical partition at the time of failure and provide a logical partition of guaranteeing necessary performance.

### Solution to Problem

A representative computer system according to the present invention is a computer system which includes a host computer, a storage device, and a management computer, in which the storage device includes a port that is connected with the host computer, a cache memory, a processor, and a plurality of logical volumes which are logical storage regions, the port, the cache memory, and the processor are divided into logical partitions as resources used for reading and writing of the logical volume for each logical volume, the host computer performs reading and writing on the logical volumes, and the management computer gives an instruction to the storage device so that resources of the logical partition in which performance of reading and writing is not guaranteed are allocated to the logical partition in which the performance of the reading and writing is guaranteed when a failure occurs in the storage device.

### Advantageous Effects of Invention

According to the present invention, it is possible to rearrange limited resources in a logical partition at the time of failure and provide a logical partition of guaranteeing necessary performance.

### BRIEF DESCRIPTION OF DRAWINGS

FIG. 1 is a diagram illustrating an example of a configuration of a computer system.

FIG. 2 is a diagram illustrating an example of a configuration of a management server.

FIG. 3 is a diagram illustrating an example of a resource management table.

FIG. 4 is a diagram illustrating an example of a logical partition management table.

FIG. 5 is a diagram illustrating an example of a resource securing upper limit management table.

FIG. 6 is a diagram illustrating an example of a resource use management table.

FIG. 7 is a diagram illustrating an example of a process flow of a resource rearrangement setting.

FIG. 8 is a diagram illustrating an example of a process flow of general resource selection.

FIG. 9A is a diagram illustrating an example of resource allocation change when a failure occurs.

FIG. 9B is a diagram illustrating an example in which there is no resource allocation change when a failure occurs.

FIG. 10 is a diagram illustrating an example of a resource securing upper limit setting change when a failure occurs.

FIG. 11 is a diagram illustrating an example of a resource information table of an FE port.

FIG. 12 is a diagram illustrating an example of a process flow of FE port resource selection.

FIG. 13 is a diagram illustrating an example of a process flow of a check of an FE port.

FIG. 14 is a diagram illustrating an example of a resource information table of an MP.

FIG. 15 is a diagram illustrating an example of a process flow of MP resource selection.

FIG. 16 is a diagram illustrating an example of a resource information table of a cache memory.

FIG. 17 is a diagram illustrating an example of a process flow of cache memory resource selection.

FIG. 18 is a diagram illustrating an example of a resource information table of a disk drive.

FIG. 19 is a diagram illustrating an example of a process flow of disk drive resource selection.

FIG. 20 is a diagram illustrating an example of a configuration of a management server that monitors an IO use state.

FIG. 21 is a diagram illustrating an example of table management information.

FIG. 22 is a diagram illustrating an example of a process flow of a resource rearrangement setting based on IO performance.

FIG. 23 is a diagram illustrating an example of a process flow of resource selection based on IO performance.

### DESCRIPTION OF EMBODIMENTS

Hereinafter, an example of a form of carryout out the present invention will be described using embodiments. Each of embodiments is to describe features of the present invention and not intended to limit the present invention. In examples described using embodiments, description will be made in detail sufficiently to enable those skilled in the art to carry out, but it is necessary to understand that other implementations or forms are also possible, and changes of configurations or structures or substitutions of various elements can be made without departing from the technical scope and spirit of the present invention.

Thus, the following description should not be interpreted to be limited to that description. A component in a certain embodiment may be added to another embodiment or may be replaced with a component in another embodiment without departing from the scope of the technical spirit of the present invention. As will be described later, the present embodiment may be implemented by software operating on a general purpose computer or may be implemented by dedicated hardware or a combination of software and hardware.

In the following description, information used in the present embodiment will be mainly described in a “table” form, but information need not be necessarily expressed in a data structure based on a table and may be expressed by a data structure such as a list, a DB, or a queues or the like.

In the following description, when each process in the present embodiment will be described using a “program” as a subject (an operation entity), the program is executed by a processor to perform a predetermined process while using a memory and a communication port (a communication control device). For this reason, description may proceed using the processor as a subject.

Further, a process disclosed using a program as a subject may be a process performed by a computer such as a management server or a storage system. A part or all of a program may be implemented by dedicated hardware or may be modularized.

Information such as a program, a table, or a file that implements each function may be stored in a storage device such as a nonvolatile semiconductor memory, a hard disk drive (HDD), or a solid state drive (SSD) or a non-transitory computer readable data storage medium such as an IC card, an SD card, or a DVD or may be installed in a computer or a computer system through a program distribution server or a non-transitory storage medium.

### First Embodiment

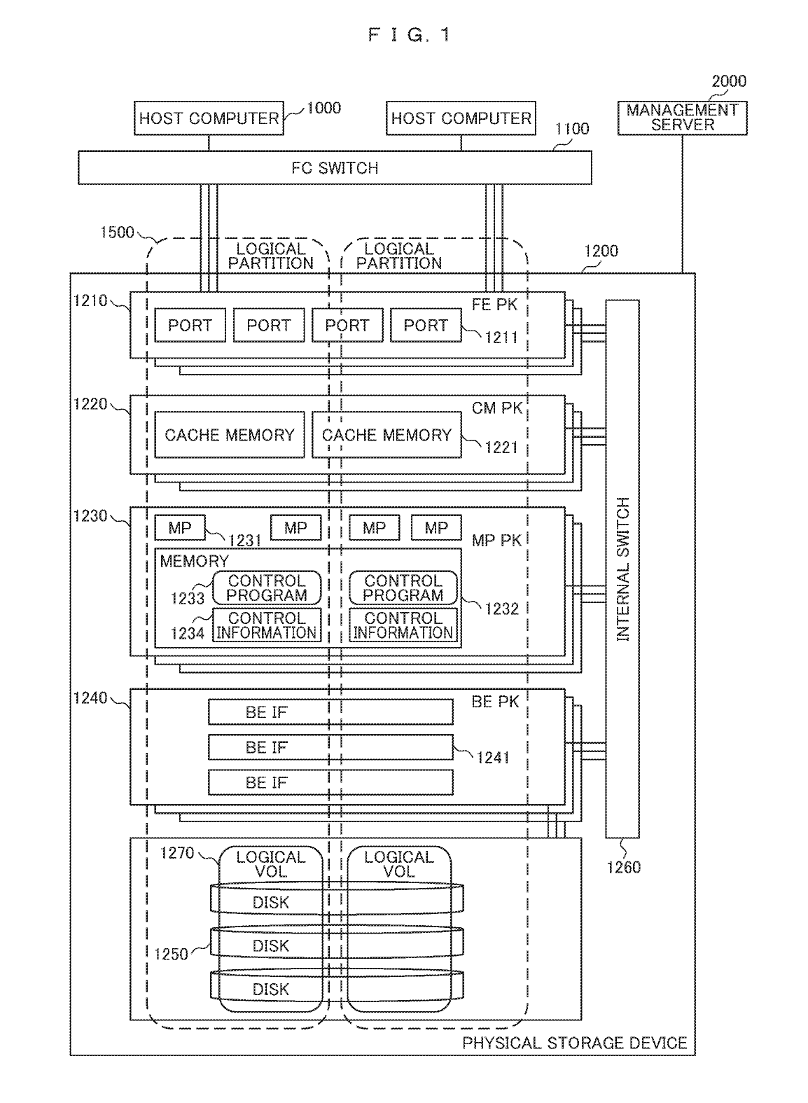

FIG. 1 is a diagram illustrating an example of a configuration of a computer system. The computer system includes a host computer 1000, a switch 1100, a physical storage device 1200, and a management server 2000. One or more devices may be provided as each of the devices.

The host computer 1000 may be a general server or a server having a virtualization function. When the host computer 1000 is a general server, an OS or an application (a DB, a file system, or the like) operating on the host computer 1000 inputs/outputs data from/to a storage region provided by a physical storage 1200. Further, when the host computer 1000 is a server having a virtualization function, an application on a virtual machine (VM) provided through a virtualization function inputs/outputs data from/to the storage region provided by the physical storage 1200.

The host computer 1000 and the physical storage device 1200 are connected by a fibre channel (FC) cable. Using this connection, the VM operating on the host computer 1000 or the host computer 1000 can input/output data from/to the storage region provided by the physical storage device 1200. The host computer 1000 and the physical storage device 1200 may be connected directly with each other, but a plurality of host computers 1000 may be connected with a plurality of physical storage devices 1200 via, for example, the switch 1100 serving as an FC switch. When there are a plurality of switches 1100, more host computers 1000 can be connected with more physical storage devices 1200 by connecting the switches 1100 to each other.

In the present embodiment, the host computer 1000 is connected with the physical storage device 1200 via an FC cable, but when a protocol such as an internet SCSI (iSCSI) is used, the host computer 1000 may be connected with the physical storage device 1200 via an Ethernet (registered trademark) cable or any other connection scheme usable for data input/output. In this case, the switch 1100 may be an Internet protocol (IP) switch, and a device having a switching function suitable for other connection schemes may be introduced.

The management server 2000 is a server for managing the physical storage device 1200. The management server 2000 is connected with the physical storage device 1200 via an Ethernet cable in order to manage the physical storage device 1200. The management server 2000 and the physical storage device 1200 may be connected directly with each other, but a plurality of management servers may be connected with a plurality of physical storage devices 1200 via an IP switch. In the present embodiment the management server 2000 and the physical storage device 1200 are connected with each other via an Ethernet cable but may be connected with each other through any other connection scheme in which transmission and reception of data for management can be performed.

As described above, the physical storage device 1200 is connected to the host computer 1000 via an FC cable, but in addition to this, when there are a plurality of physical storage devices 1200, the physical storage devices 1200 may be connected to each other. The number of host computers 1000, the number of switches 1100, the number of physical storage devices 1200, and the number of management computers 2000 may be any number regardless of the numbers illustrated in FIG. 1 as long as it is one or more. Further, the management server 2000 may be stored in the physical storage device 1200.

The physical storage device 1200 is divided into a plurality of logical partitions (LPAR) 1500 and managed by the management server 2000. The physical storage device 1200 includes a front end package (FEPK) 1210, a cache memory package (CMPK) 1220, a micro-processor package (MPPK) 1230, a back end package (BEPK) 1240, a disk drive 1250, and an internal switch 1260. The FEPK 1210, the CMPK 1220, the MPPK 1230, and the BEPK 1240 are connected with one another via a high-speed internal bus or the like. This connection may be performed via the internal switch 1260.

The FEPK 1210 has one or more ports 1211 which is a data input/output interface (front end interface) and is connected with the host computer 1000, other physical storage devices 1200, or the switch 1100 via the port. When data input/output is performed through communication via an FC cable, the port is an FC port, but when data input/output is performed in other communication forms, an interface (IF) suitable for the form is provided.

The CMPK 1220 includes one or more cache memories 1221 which are a high-speed accessible storage region such as a random access memory (RAM) or an SSD. The cache memory 1221 stores temporary data when an input/output to/from the host computer 1000 is performed, setting information causing the physical storage device 1200 to perform various kinds of functions, storage configuration information, and the like.

The MPPK 1230 is configured with a micro-processor (MP) 1231 and a memory 1232. The MP 1231 is a processor that executes a program which is stored in the memory 1232 and performs an input/output with the host computer 1000 or a program that performs various kinds of functions of the physical storage device 1200. When the processor that executes the program for performing an input/output with the host computer 1000 or the program for performing various functions of the physical storage device 1200 is configured with a plurality of cores, each of the MPs 1231 illustrated in FIG. 1 may be a core.

The memory 1232 is a high-speed accessible storage region such as a RAM, and stores a control program 1233 which is a program for performing an input/output with the host computer 1000 or a program of performing various functions of the physical storage device 1200 and control information 1234 which is used by the programs. Particularly, in the present embodiment, logical partition information for controlling various functions of an input/output processing or storage according to a set logical partition is stored.

The number of MP 1231 and the number of memories 1232 may be any number regardless of the numbers illustrated in FIG. 1 as long as it is one or more. The MPPK 1230 has an interface for management and is connected to the management server 2000 via the MPPK. When the physical storage device 1200 is managed through communication via the Ethernet cable, an Ethernet port is used, but when the physical storage device 1200 is managed in other communication forms, an IF suitable for the form is provided.

The BEPK 1240 includes a back end interface (BEIF) 1241 which is an interface for a connection with the disk drive 1250. As this connection form, a small computer system interface (SCSI), a serial AT attachment (SATA), or a serial attached SCSI (SAS) is commonly used, but any other connection form may be used. The disk drive 1250 is a storage device such as an HDD, an SSD, a CD drive, a DVD drive, or the like. The number of FEPKs 1210, the number of CMPKs 1220, the number of MPPKs 1230, the number of BEPKs 1240, the number of disk drives 1250, and the number of internal switches 1260 may be any number regardless of the numbers illustrated in FIG. 1 as long as it is one or more.

Here, the control program 1233 of the present embodiment will be described. The control program 1233 includes a data input/output processing program included in a common storage device. The control program 1233 can constitute a redundant arrays of inexpensive disks (RAID) group using a plurality of disk drives 1250 and provide a logical volume (logical VOL) 1270 obtained by dividing it one or more logical storage regions to the host computer 1000. In this case, the data input/output process includes a process of converting an input/output to/from the logical volume 1270 into an input/output to/from the physical disk drive 1250. In the present embodiment, a data input/output to/from the logical volume 1270 is assumed to be performed.

Further, the data input/output process is controlled such that each logical partition 1500 performs a process using only allocated resources in order to avoid performance influence between the logical partitions 1500. For example, when an input/output is performed, a processing capability of the MP 1231 is used, but when the use rate of the MP 1231 is allocated 50%, the use rate is monitored. Further, when the use rate exceeds 50%, the process of the logical partition 1500 enters a sleep state, and the MP 1231 is handed over to a process of another logical partition 1500.

Alternatively, in the data input/output process, for example, control is performed such that when the use rate of the cache memory 1221 is allocated 50%, the use rate is monitored, and when the use rate exceeds 50%, a part of the cache memory 1221 used in the logical partition is destaged and released to create an empty region, and then a process proceeds.

It is unnecessary to specify a method of performing a process as long as a process is performed using only allocated resources. In other words, it is desirable that the physical storage device 1200 can perform the process using allocated resources such that the process of each logical partition 1500 is not influenced by other logical partitions 1500.

Further, the control program 1233 may have a remote copy function of copying data between the two physical storage devices 1200. In the remote copy, the MP 1231 reads data of the logical volume 1270 of a copy source, and transmits the data to the physical storage device 1200 including the logical volume 1270 of a copy destination via the port 1211. The MP 1231 of the physical storage device 1200 including the logical volume 1270 of the copy destination receives the transmission via the port 1211 and writes the data in the logical volume 1270 of the copy destination. Accordingly, all the data of the logical volume 1270 of the copy source is copied to the logical volume 1270 of the copy destination.

Further, during the copy, writing to the copied region needs to be performed in both the logical volume 1270 of the copy source and the logical volume 1270 of the copy destination. Therefore, a write command to the physical storage device 1200 of the copy source is transferred to the physical storage device 1200 of the copy destination. The functions of the physical storage devices 1200 can be variously enhanced and simplified, but since the present embodiment can be applied to those functions without changing the substance, the present embodiment will be described on the premise of the above functions.

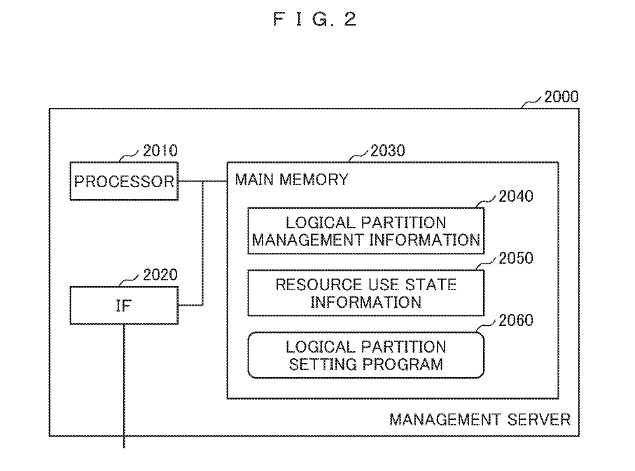

FIG. 2 is a diagram illustrating an example of a configuration of the management server 2000. The management server 2000 is configured with a processor 2010 which is a central processing unit (CPU), an input/output IF 2020, and a memory 2030. The processor 2010 is a device that executes various programs stored in the memory 2030. The input/output IF 2020 is an interface that receives an input from a keyboard, a mouse, a tablet, a touch pen, or the like and performs an output to a display, a printer, a speaker, or the like. The memory 2030 is a data storage region such as a RAM and stores various programs, data, temporary data, or the like. Particularly, in the present embodiment, logical partition setting management information 2040, resource use state information 2050, and a logical partition setting program 2060 are stored in the memory 2030.

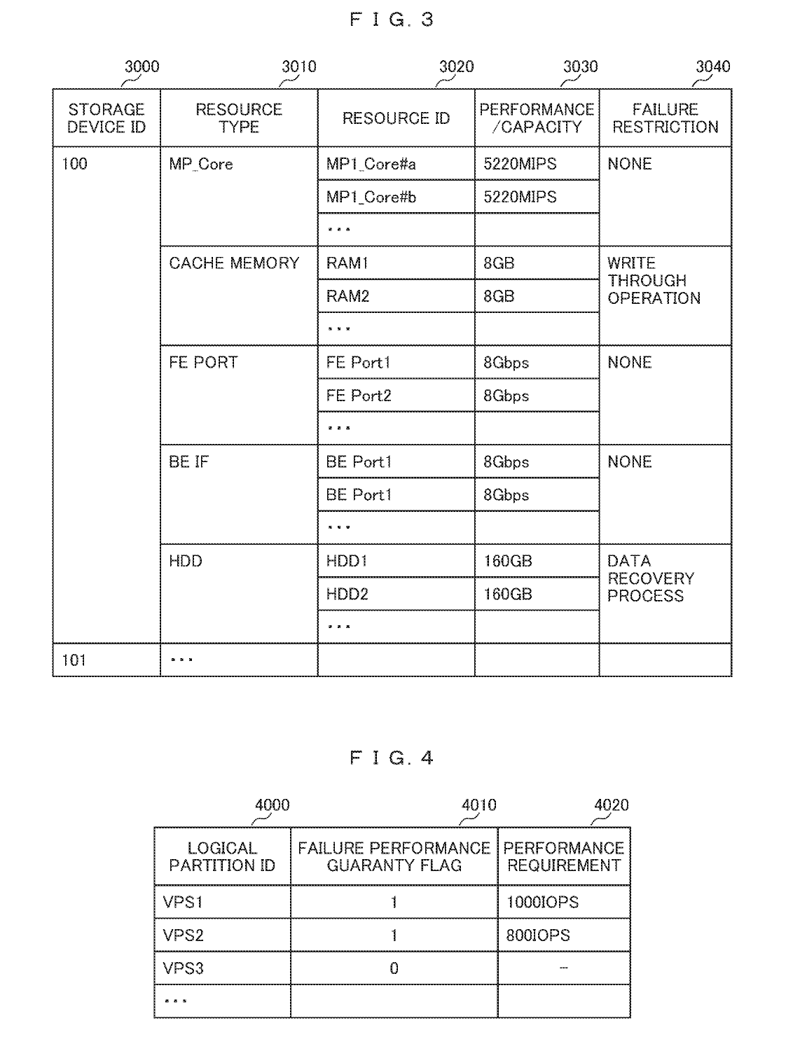

FIG. 3 is a diagram illustrating an example of a resource management table constituting the logical partition setting management information 2040. A storage device ID 3000 stores an ID of the physical storage device 1200 in the present computer system. A type of resources belonging to the physical storage device 1200 indicated by the stored ID is stored in a resource type 3010, and an ID indicating the entity of each resource is stored in a resource ID 3020. Maximum performance and maximum capacity of each resource are stored in performance/capacity 3030.

In the present embodiment, “MP_Core” indicating a core of the MP 1231, “cache memory” indicating the cache memory 1221, “FE port” indicating the port 1211, “BE IF” indicating a BE IF 1241, and “HDD” indicating the disk drive 1250 are stored in the resource type 3010. A processing speed (MIPS) of the core of the MP 1231, capacities (GB) of the cache memory 1221 and the disk drive 1250, and performance (Gbps) of the FE port 1211 and the BE IF 1241 are stored in the performance/capacity 3030.

Restriction information of reach resource when a failure occurs is stored in a failure restriction 3040. In the case of a cache memory, since data is likely to be lost at the time of failure, for example, restriction information in which a write through operation is performed, and writing performance deteriorates is stored. In the case of an HDD, when it has a RAID configuration, restoration information in which a data recovery process of a disk drive in which a failure has occurred is performed, and access performance in a RAID group deteriorates is stored. The logical partition setting program 2060 sets the values in advance based on an input from the user or information collected from the physical storage device 1200.

FIG. 4 is a diagram illustrating an example of a logical partition management table constituting the logical partition setting management information 2040. A logical partition ID 4000 is an ID of the logical partition 1500. Information indicating whether a logical participation is a logical partition which should guarantee performance at the time of failure or a logical partition which performs a degenerated operation is stored in a performance guaranty flag 4010. A performance requirement which is set in the logical partition ID in advance is stored in a failure performance requirement 4020. The logical partition setting program 2060 sets the values when the user creates the logical partition 1500.

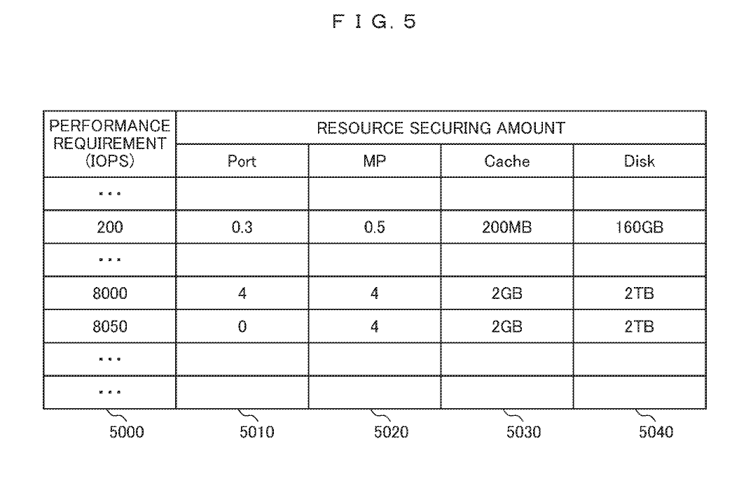

FIG. 5 is a diagram illustrating an example of a resource securing upper limit management table constituting the logical partition setting management information 2040. When the performance requirement set in the logical partition ID is set in the performance requirement 4020, information of an upper limit of a resource securing amount allocated to the logical partition is stored. For example, a logical partition in which an input/output operations per second (IOPS) indicating IO performance of the host computer 1000 and the logical partition 1500 satisfies 200 IOPS secure resources using a frame in which the port 1211 is 0.3, the MPs 1231 is 0.5, the cache memory 1221 is 200 MB, and the disk drive 1250 is 160 GB as the upper limit.

Here, the resource upper limit satisfying the IOPS may be created based on statistical information when a predetermined load is applied to the storage device. Since four resource securing amount patterns may vary greatly depending on circumstances, resource allocation for satisfying a predetermined IOPS may be changed according to the IOPS measured by the management server and the use state of resources. A resource use state of a state close to the IOPS of the performance requirement may be stored, and the resource securing upper limit management table may be updated based on the value. Alternatively, by using a relation between a current IOPS and a resource amount used at that time, the resource securing upper limit at the time of the IOPS of the performance requirement may be updated based on a value proportional to the relation. When the resources are secured, a resource amount satisfying the performance requirement is set even when the load is within an assumed range.

Each logical partition 1500 may be allocated specific resource by an upper limit amount from the beginning, and the allocation may be an ownership of the resources of each logical partition 1500. In this case, a flag indicating the logical partition 1500 that owns each resource may be set for each resource such as the port, the cache memory, the MP, and the disk drive. Thus, for example, the logical partition 1500 whose resources are lent and the logical partition 1500 to which the resources are lent become clear, and there is a merit in which it is easy to perform a resource lending/borrowing process linked with the performance guaranty flag.

The upper limit may also mean an upper limit of an authority capable of securing resources. A specific ownership of resource is not set, the management server 2000 manages all resources of the physical storage device 1200, and each logical partition 1500 manages an authority capable of lending (securing) necessary resources. Thus, the management server 2000 manages a used amount and an unused amount of all the resources and designates an amount to be released by the logical partition 1500, and thus the amount released by the logical partition 1500 can be used by other logical partitions 1500. As described above, the resources are shared, and based on the authority capable of securing the resources of the upper limit set in each logical partition 1500, each logical partition 1500 secures the resources from the shared resources. For resource management, any other configuration of management may be used.

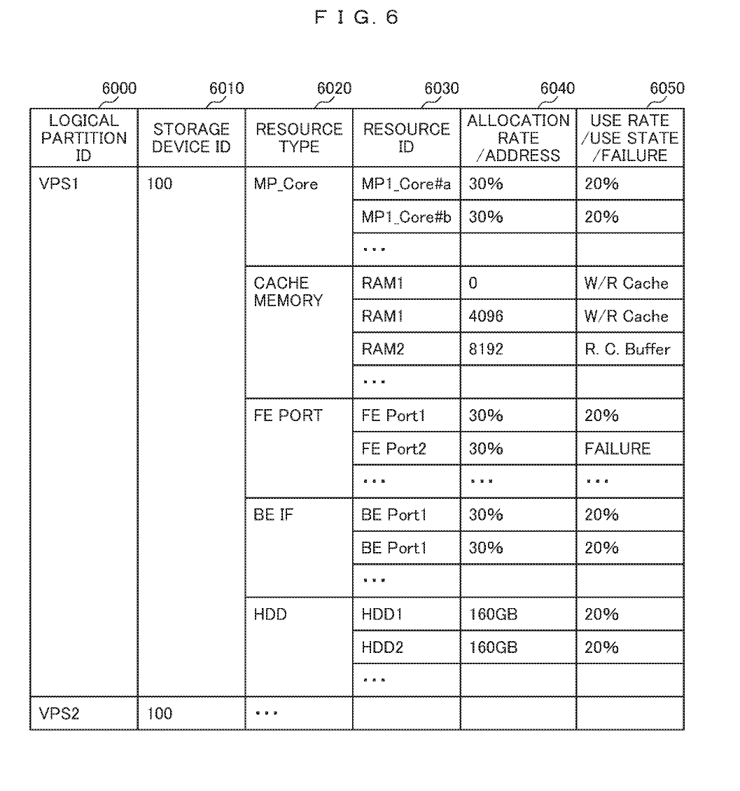

FIG. 6 is a diagram illustrating an example of a resource use management table constituting the resource use state information 2050. An ID of the logical partition 1500 is stored in a logical partition ID 6000. An ID of the physical storage device 1200 in the present computer system constituting the logical partition ID 6000 is stored in a storage device ID 6010. Information indicating the resources allocated to the logical partition 1500 includes a resource type 6020, a resource ID 6030, an allocation rate/address 6040, and a use rate/use state/failure 6050. A type of allocated resources is stored in the resource type 6020. In the present embodiment, “MP_Core” indicating the core of the MP 1231, “cache memory” indicating the cache memory 1221, “FE port” indicating the port 1211, “BE IF” indicating the BE IF 1241, and “HDD” indicating the disk drive 1250 are stored.

An ID of allocated specific resources is stored in the resource ID 6030. A meaning of the value stored in the allocation rate/address 6040 changes according to the resource type. If the resource type 6020 indicates “MP_Core,” “FE port,” and “BE IF,” a ratio which can be used by the logical partition 1500 for a maximum performance of each resource is stored. When the resource type 6020 indicates “cache memory,” an address of a usable block is stored. In the present embodiment, blocks are assumed to be created in units of 4 kB (4096 bytes), and a start address of each block is stored here. In the case of the disk drive 1250, a usable capacity is stored here.

A meaning of a value stored in the use rate/use state/failure 6050 also changes according to the resource type. When the resource type 6020 indicates “MP_Core,” “FE port,” “BE IF,” and “HDD,” a ratio used by the logical partition 1500 for a maximum performance/capacity of each resource is stored. When the resource type 6020 is “cache memory,” the use state of the cache memory 1221 is stored.

The use state indicates data which is stored in the cache memory 1221. For example, the use state is a write/read cache which is used as a cache that receives a write/read command from the host computer 1000 and holds data to be written in the disk drive 1250 and a cache that holds data read from the disk drive 1250. The use state may be a remote copy buffer (R.C. buffer) in which write data generated during a remote copy is temporarily stored or may temporarily serves as a remote copy buffer and then serves as a R.C. buffer in which copied data is stored (transferred).

In the case of unused, a value of the use rate/use state/failure 6050 in which “- (hyphen)” or the like is stored is a value obtained by adding a lent amount as well when resources are lent to other logical partitions 1500. For example, when the logical partition 1500 of the lending source uses 10% of MP_Core, and 10% of the same MP_Core is lent to other logical partitions 1500, the value of the use rate/use state/failure 6050 is 20%. In the case of “FE port,” “BE IF,” and “HDD,” similarly, the value of the use rate/use state/failure 6050 is a value obtained by adding the lent amount.

In the case of “cache memory,” the use state in the lending destination is stored in the use rate/use state/failure 6050. Further, when a failure occurs, failure information is stored. Furthermore, when the use rate of the remote copy buffer is high, control may be performed such that the remote copy buffer is fully filled by restricting the inflow of data from the host computer 1000 to the logical partition 1500, but in the case of the logical partition in which the performance guaranty flag is set, a remote buffer allocation amount may be increased to prevent a decrease in the IOPS between host computer 1000 and logical partition 1500.

If it is predicted that the use rate will be 80% or more within a certain period based on a remote copy buffer use rate at a predetermined point in time and a use increasing rate for a certain period from a predetermined point in time, a process of increasing an amount of the remote copy buffer to be 60% within a predetermined period may be performed. Thus, the IOPS of the performance requirement can be maintained. The value of the resource use management table is set by the logical partition setting program 2060 when the user creates the logical partition. Further, the use rate/use state/failure 6050 is updated by periodical monitoring performed by the logical partition setting program 2060.

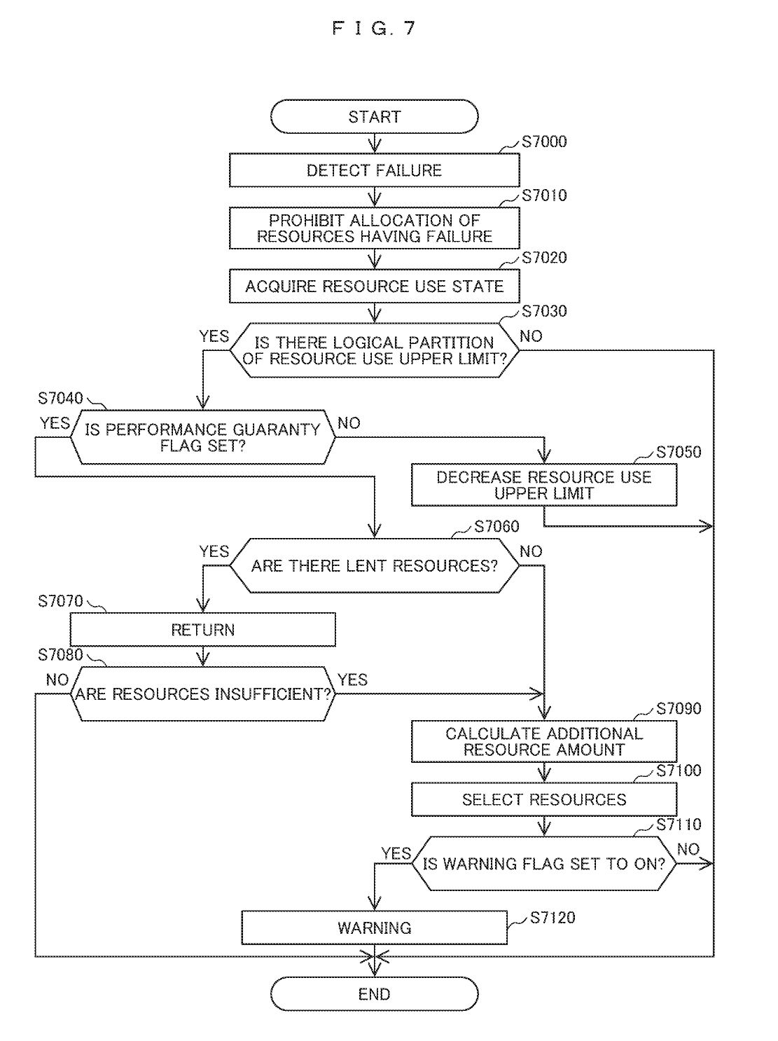

Next, the flow of a process of the logical partition setting program 2060 will be described. FIG. 7 is a diagram illustrating an example of a process flow of a resource rearrangement setting performed by the logical partition setting program 2060 when a failure occurs. The process flow illustrated in FIG. 7 is activated periodically through a scheduler of the management server 2000 and starts.

When activated, the processor 2010 acquires failure detection information from the physical storage device 1200 (S7000), and when there is a resource having a failure, the processor 2010 performs an allocation prohibition process so that the resource is not allocated to the logical partition (S7010). The use state of each resource of each logical partition 1500 is acquired, and the resource use management table illustrated in FIG. 6 is updated (S7020). As a failure has occurred, it is checked whether or not there is a virtual storage whose resource use reaches the logical partition securing upper limit (S7030).

When NO is determined in S7030, since it is a situation in which the process is being performed without using currently allocated resources although a failure has occurred, the processor 2010 ends the process without performing resource rearrangement. When YES is determined in S7030, the processor 2010 checks whether or not the logical partition guarantees the performance when a failure occurs based on the performance guaranty flag 4010 with reference to the logical partition management table illustrated in FIG. 4 (S7040).

When the performance guaranty flag 4010 is not set, the resources that can be secured by the logical partition due to a failure are restricted, and it is difficult to guarantee the performance. At this time, the resource securing upper limit setting for satisfying the performance requirement set in the logical partition is decreased (S7050). In other words, because the resource amount that can be used by logical partition which is unable to guarantee the performance due to a failure is decreased, it is necessary to decrease the upper limit setting so that the decrease is not supplemented by other resources.

When the performance guaranty flag is set (YES) in S7040, the processor 2010 checks the presence or absence of unused resources which are lent to other logical partitions (S7060). When there are lent resources, the logical partition of the lending destination is requested to perform a return process, and the resources are recovered (S7070). When it is possible to secure the resource satisfying the performance through this collection (NO in S7080), the process ends.

When there are no lent resources (NO in S7060) or when resources are insufficient (YES in S7080), the processor 2010 calculates the resource amount necessary for guaranteeing the performance (S7090). It may be calculated with reference to the resource securing amount for the performance requirement (IOPS) illustrated in FIG. 5 or may be calculated based on the resource amount of the failure that has occurred. A resource amount equivalent to the resource amount of the failure that has occurred may be necessary.

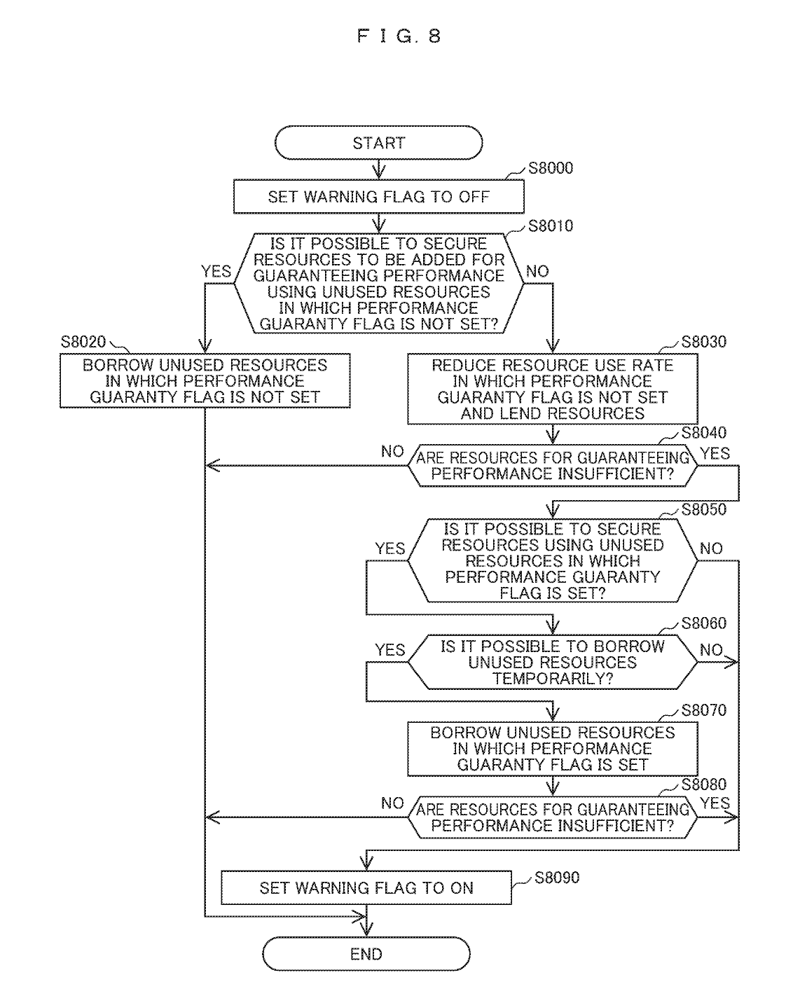

The processor 2010 performs a resource selection process (S7100). In the resource selection process, it is determined whether or not it is possible to guarantee the performance in the in the logical partition in which the performance guaranty flag is set, and when it is difficult to guarantee the performance, a warning flag is set to ON (which will be described with reference to FIG. 8). When the warning flag is on, a notification indicating that it is difficult to guarantee the performance is given to the administrator through the IF 2020 (S7120).

FIG. 8 is a diagram illustrating an example of a process flow of resource selection performed by the logical partition setting program 2060 when a failure occurs. The resource selection is the process of S7100 described above with reference to FIG. 7. The processor 2010 determines whether or not a notification indicating that it is difficult to guarantee the performance is given to the administrator through a later process, the warning flag is set to OFF as an initial setting (S8000). First, it is checked whether or not it is possible to add the resources of the logical partition in which the performance guaranty flag is set using unused resources of the logical partition to which the performance guaranty flag is not set (S8010).

This can be confirmed by calculating an amount of unused resources with reference to the resource use management table illustrated in FIG. 6. When it is possible to secure necessary resources (YES in S8010), the processor 2010 performs the process of borrowing the unused resources of the logical partition in which the performance guaranty flag is not set (S8020). First, by borrowing the unused resources, it is possible to prevent a decrease in a current performance whenever possible even in the logical section in which the performance guaranty flag is not set.

When it is difficult to secure resources using only unused resources (NO in S8010), the processor 2010 reduces the resources used by the logical partition in which the performance guaranty flag is not set, secures resources, and lends the secured resources (S8030). The resources are released in order starting from the logical partition in which the used resource amount is small with reference to the resource use management table illustrated in FIG. 6.

For example, in the case of a cache, the destage process is necessary when the resources are released, and when a target region of the destage process is wide, it takes much time for the destage process, and thus a time in which there is influence of the destage process is increased. For this reason, when the release process is performed starting from the logical partition in which the used region is small, there is a possibility that it is possible to reduce a time in which the performance is influenced. Further, a region that has undergone the destage process is used as an unused region.

When it is difficult to secure resources for solving the performance deterioration caused by a failure although S8030 is performed (YES in S8040), the processor 2010 checks whether or not it is possible to borrow unused resources of the logical section in which the performance guaranty flag is set (S8050 and S8060). The borrowing is lending and borrowing of resources between the logical sections in which the performance guaranty flag is set, but a priority is given to an operation of the logical partition of lending the resources.

In other words, even after the logical partition that lends the resources temporarily lends the resources, when the logical partition that has lent the resources needs resources, it is required to immediately return the resources regardless of a situation of the logical partition that has borrowed the resources. In this case, the performance is not guaranteed by the logical partition that has borrowed the resources, but a process according to a situation of the logical partition that has lent the resources is performed.

In this embodiment, checking whether or not it is possible to secure the resources (S8050) and checking whether or not it is possible to temporarily lend securable resources (S8060) are separately performed, but the two checking processes may be performed through one determination process. When it is possible to lend the resources (YES in S8060), the processor 2010 performs a process of borrowing the unused resources of the logical partition in which the performance guaranty flag is set (S8070). When it is difficult to secure resources for solving the performance deterioration caused by a failure although S8070 is performed (YES in S8080), the processor 2010 sets the warning flag for giving a notification indicating that it is difficult to guarantee the performance in the logical partition in which performance guaranty flag is set to ON (S8090).

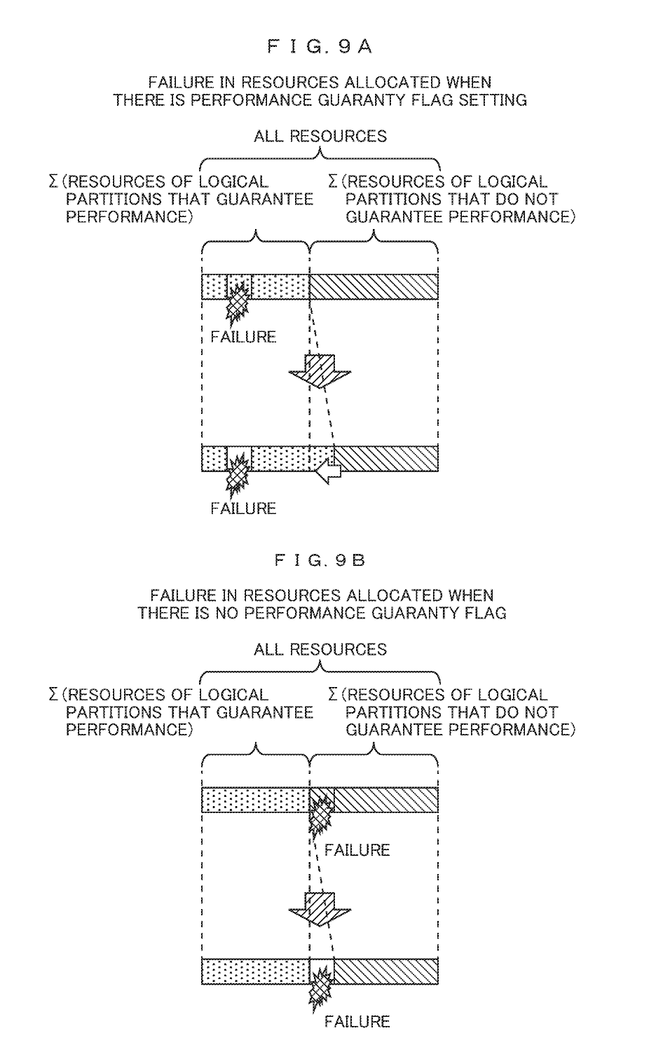

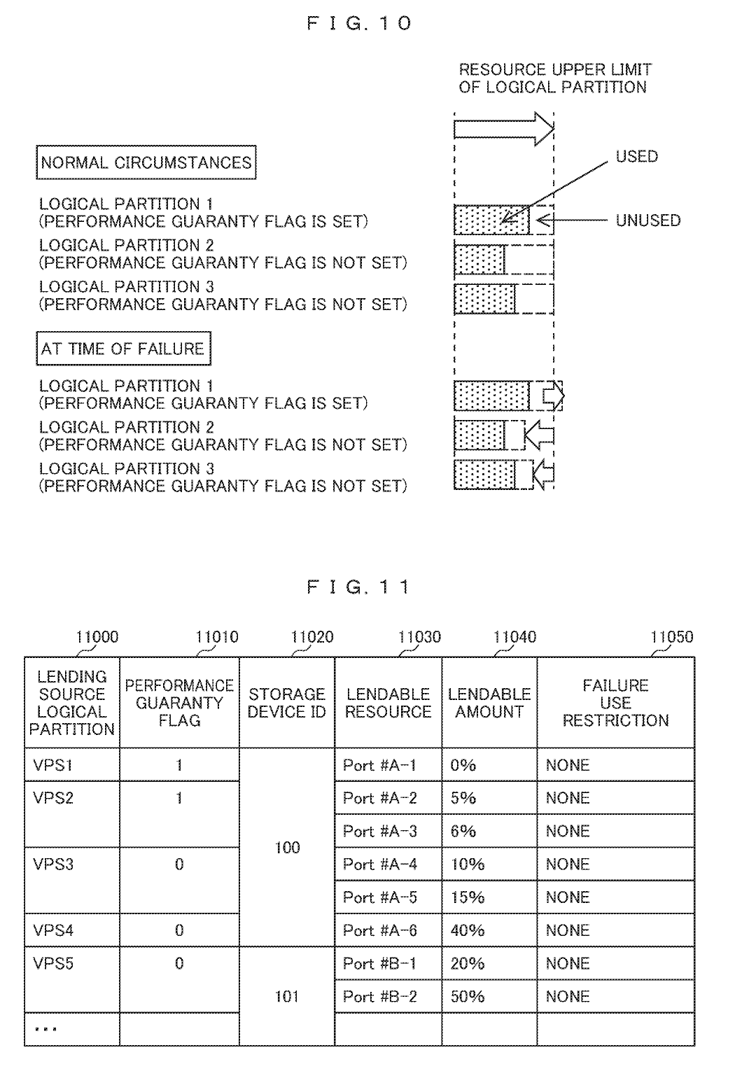

FIGS. 9A, 9B, and 10 are diagrams illustrating an example of changing a resource securing upper limit setting change of the logical partition when a failure occurs. FIGS. 9A, 9B, and 10 are examples of the result of the process performed by the logical partition setting program 2060 described above with reference to FIGS. 7 and 8.

FIG. 9A is a diagram illustrating an example in which a failure occurs in resources allocated to a logical partition in which the performance guaranty flag setting is enabled. In this case, in order to guarantee the performance, the resources of the logical partition in which the performance guaranty flag is not set are allocated to the logical partition in which the performance guaranty flag is set (a leftward arrow illustrated in FIG. 9A). The resources available for the logical partition that does not guarantee the performance are reduced accordingly, and the best effort performance is obtained in a situation in which the resources are limited. At this time, since a total amount of available resources is decreased, it is necessary to reduce the resource upper limit set in the logical partition as in S7050 illustrated in FIG. 7.

FIG. 9B is a diagram illustrating an example in which a failure occurs in resources allocated to a logical partition in which the performance guaranty flag setting is disabled. Since the performance of the logical partition in which the performance guaranty flag is enabled is not directly influenced by a failure, the rearrangement is not performed, and resource available for the logical partition in which the performance guaranty flag is disabled are reduced. It is also necessary to reduce the resource upper limit set in the logical partition similarly to the description made with reference to FIG. 9A.

FIG. 10 is a diagram illustrating an example of the resource upper limit of each logical partition in normal circumstances and at the time of a failure. In normal circumstances, the resource upper limit of the logical partition is determined in advance, and a necessary amount of resources are used within the range of the upper limit. At the time of a failure, since a total amount of available resources decreases, the resource upper limits of logical partitions 2 and 3 in which the performance guaranty flag is disabled are reduced, and necessary resources in the frame is allocated and used. FIG. 10 illustrates an example in which in order to reduce influence on a process that is being performed, a decrease width of the resource upper limit of the logical partition larger having many unused resources is large. On the other hand, the resource upper limit of the logical partition 1 in which the performance guaranty flag is enabled is large.

Basically, in the logical partition in which the performance guaranty flag is enabled, the performance is not influenced when the resource upper limit is the same as that before a failure occurs, but a safety factor for guaranteeing the performance may be prepared in advance depending on a position at which a failure occurs. This is a factor in which influence on others is considered depending on a position at which a failure occurs, and the upper limit of the logical partition increases according to this factor. For example, when a failure occurs in an MP which uses the logical partition in which the performance guaranty flag is set, more MP resources than the original upper limit are allocated in order to change scheduling so that a process is not performed in the MP, and thus the performance can be guaranteed even at the time of a failure.

Further, for example, when a failure occurs in an HDD configured with a RAID 5 or a RAID 6, the recovery process of recovering data of the HDD having the failure is performed based on information stored around the HDD having the failure. In the recovery process of data, access to a plurality of physical HDDs occurs, and for example, due to a switching process in the BE IF 1241, the logical partition may be influenced by a failure occurring in resources (HDD) having no direct influence. In this case, in order to increase the processing speed, allocation of more cache resource than the resource upper limit described above with reference to FIG. 5 may be set.

FIG. 10 is a diagram illustrating an example of lending resources from the logical partitions 2 and 3 to the logical partition 1 at the time of a failure, that is, an example in which resources are first borrowed from the logical partition having a high resource non-use rate, and insufficient resources are then borrowed from the logical partition 3 having a high non-use rate.

The upper limit of the resources in which a failure has occurred may be increased or decreased in proportion to an increase or decrease amount of the upper limit of the resource in which no failure occurs. When the upper limit of the resources in which a failure has occurred is decreased, a use amount of other resources in which a failure does to occur also reduced, and thus an amount of resources that can be lent when other logical partitions need resources is increased. Further, when the upper limit of the resources in which a failure has occurred, resources in which no failure occurs are likely to be used more than the currently secured upper limit, and thus resources necessary for guaranteeing the performance are secured by increasing the upper limit proportionally.

FIG. 11 is a diagram illustrating an example of the resource management information table of the port 1211 allocated to the respective logical partitions. The resource management information table of the port 1211 is referred to in the logical partition setting program 2060. This table indicates an amount of resources that can be lent, but it indicates a resource amount of unused resources that are lent excluding a margin of X % (X is a value which is set in advance) of unused resources in addition to the amount of used resources described above with reference to FIG. 6. The port 1211 having unused resources that can be borrowed is checked based on this table. The table is used in the resource selection process of S7100 in the process described above with reference to FIG. 7.

The logical partition can borrow the port 1211 only by enabling an available path and making a change so that a port number of the logical partition is used when a multipath setting is performed so that a path is not used in normal circumstances, but a path can be used immediately in order to cope with a failure, and thus it is possible to borrow and lend with no performance deterioration. However, when a path available for the logical partition is not set, it is necessary to generate a path newly. Therefore, in order to prevent the IOPS performance from deteriorating due to a time taken for path generation, a process of preferentially allocating a port having a multipath setting is performed.

Since there is a cache in a physical port, IO data is transferred to a previously set port while data remains in the cache, and thus there are cases in which it is on standby until the port cache is cleared. At this time, the port cache is temporarily turned off, and a port switching process is performed.

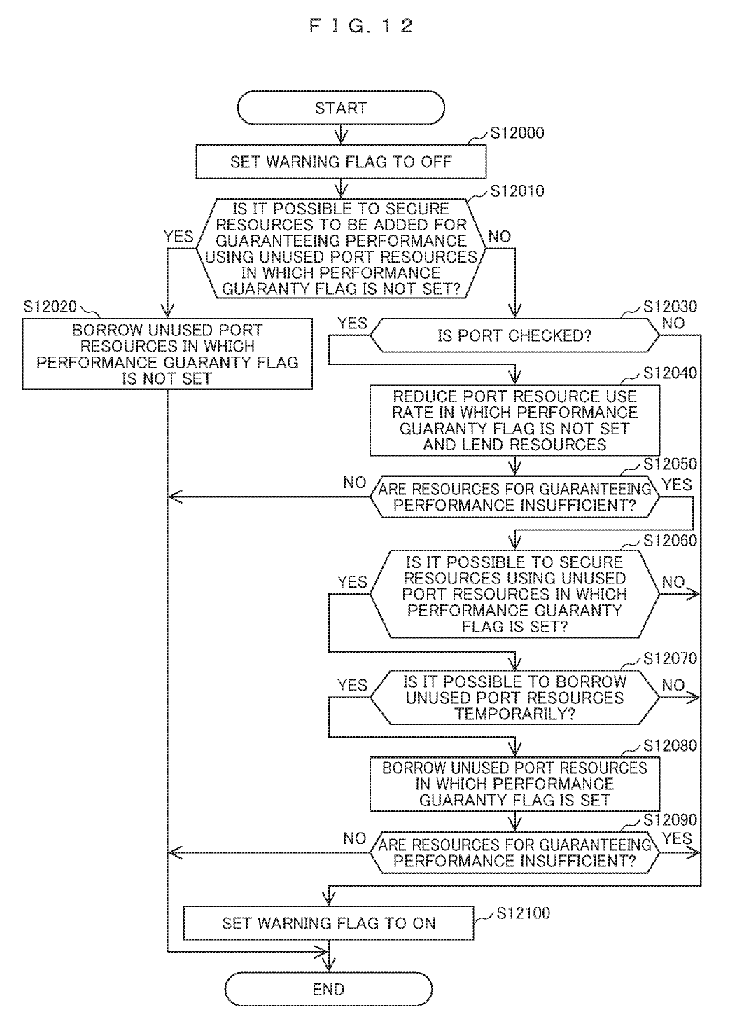

According to the resource information management table, it is difficult to select resources only from a lendable resource amount 11040, and thus a place from which resources are borrowed to supplement insufficient resources at the time of a failure is determined using this table in the process flow described above with reference to FIG. 12. For example, when resources of an FE port of a VPS 2 in which a performance guaranty flag 11010 is enabled (“1”) are insufficient, first, ports #A-4, A-5, and A-6 and ports #B-1 and B-2 (lendable resource 11030) having no performance guaranty flag 11010 are selected.

Since the ports #B-1 and B-2 allocated to the VPS 5 (the lending source logical partition 11000) indicate that a storage device ID 11020 is another storage device, it is likely to take time to change the storage device configuration. In this regard, first, the ports #A-4, A-5, and A-6 indicating the inside of the storage devices having the same storage device ID 11020 are selected, and the port #A-6 in which the value of the lendable amount 11040 is largest is selected among the ports #A-4, A-5, and A-6. Since there is a risk when a port having a setting of a failure use restriction 11050 is selected, the port is not selected.

The lending and borrowing performed in units of ports have been described above, but one port may be used in a time division manner, and resources may be distributed at allocated times.

FIG. 12 is a diagram illustrating an example of a process flow of FE port resource selection performed in S7100 of FIG. 7. This process flow is a part of the logical partition setting program 2060. In the case of the FE port, the process follow of borrowing the FE port in the logical partition is completed only by changing the port number of the logical partition when multiple paths are established, and thus the process is basically the same as the process flow described above with reference to FIG. 8. Thus, different portions of the process will be described.

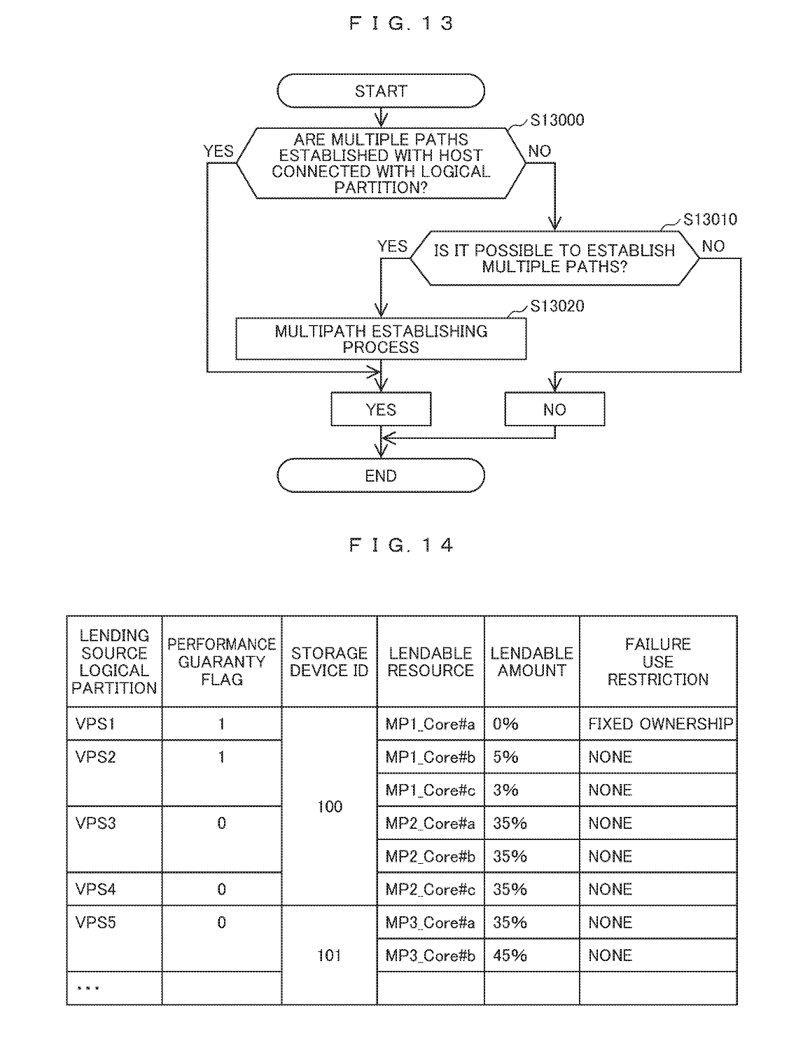

In port checking of S12030, when the FE port is checked, and it is determined that resources can be borrowed (YES in S12030), the processor 2010 performs the process already described with reference to FIG. 8. When NO is determined the port checking of S12030, it is difficult to secure resources, and thus a process S12100 of giving a notification indicating that it is difficult to secure resources to the administrator is performed. Content of the port checking process will be further described with reference to FIG. 13.

FIG. 13 is a diagram illustrating an example of a process flow of prior checking of whether or not resources of the FE port can be allocated in S12030 of FIG. 12. This process flow is a part of the logical partition setting program 2060. First, the processor 2010 checks whether multiple paths are established with the host computer 1000 connected with the logical partition (S13000). When the multiple paths are established (YES in S13000), resources can be allocated only by changing the port number of the logical partition. In this case, “YES” is set, and the process ends.

When the multiple paths are not established (NO in S13000), the processor 2010 checks whether or not it is possible to establish multiple paths (S13010). For example, it is difficult to establish multiple paths when the host computer 1000 and the physical storage device 1200 are not actually connected with each other, and when it is necessary to greatly change the configuration management information of the physical storage device 1200, it takes a lot of time for a multipath establishing process, and thus it is determined that it is difficult to establish the multiple paths.

When it is possible to establish the multiple paths (YES in S13010), the processor 2010 performs the multipath establishing process (S13020), and thus since lending and borrowing of resources in the logical partition can be freely performed, “YES” is set, and the process end. When the host computer 1000 and the physical storage device 1200 are not connected or when it is difficult to establish the multiple paths in terms of the configuration of the physical storage device 1200 (NO in S13010), “NO” is set, and the process end.

FIG. 14 illustrates the resource management information table of the MP 1231 allocated to each logical partition. The resource management information table of the MP 1231 is referred to in the logical partition setting program 2060. There are cases in which an authority (ownership) that allows only a predetermined MP 1231 to acquire information of an arbitrary logical volume 1270 is set. In this case, since the data input/output process is performed on the arbitrary logical volume 1270, when configuration information and setting information of the arbitrary logical volume 1270 are stored in the local memory 1232 from the cache memory 1221 once, the MP 1231 need not access the cache memory 1221 to acquire the configuration information and the setting information.

The MP resource arrangement is switching the ownership of using the MP, and the MP can be used in another logical partition by switching of the ownership. Basically, the process flow of the MP resource selection is the same as the process flow already described with reference to FIG. 8. The process flow described above with reference to FIG. 8 differs from the process flow of the MP resource selection in that the resource management information table of the MP 1231 illustrated in FIG. 14 is used as a reference for selecting unused resources.

The sleep period of the MP 1231 may be identified as a non-use period. Since the sleep period of the MP 1231 is a period during which the MP 1231 is not used, the allocation of the MP resources are adjusted by performing the scheduling process so that this period is used by other logical partitions. The lending and borrowing of the MP resources may be lending and borrowing in units of MPs 1231 rather than units of cores of the MPs 1231.

When the lending and borrowing of resources are performed units of cores, the L2 cache in the MP 1231 is shared with the processes of other logical partitions, and there is a possibility that the performance is influenced by other logical partitions. When there is no such possibility, the lending and borrowing of resources may be performed in units of MPs 1231. Furthermore, when there is influence if the memory 1232 in the MPPK 1230 or a bus (not illustrated) is shared, it is desirable to allocate the memory 1232 or the bus also for each logical partition.

For example, when MP resources of the VPS 2 in which the performance guaranty flag is enabled are insufficient, MP2_Cores #a, b, and c and MP3_Cores #a and b in which the performance guaranty flag is set are selected. Since MP3_Cores #a and b allocated to the VPS 5 are different physical storage devices, MP2_Cores #a, b, and c in the same physical storage device are first selected.

The lendable amounts of the selected MP2_Cores #a, b, and c are equal, that is, all 35%, but since the two MP2_Cores #a and b are allocated to the VPS 3, the lendable amount of the VPS 3 is larger than that of the VPS 4. For this reason, MP2_Core #a is selected, and the process of lending the MP resources to the VPS 2 is performed. An MP having a failure restriction in which an ownership is fixedly used at the time of a failure is low in a selection priority.

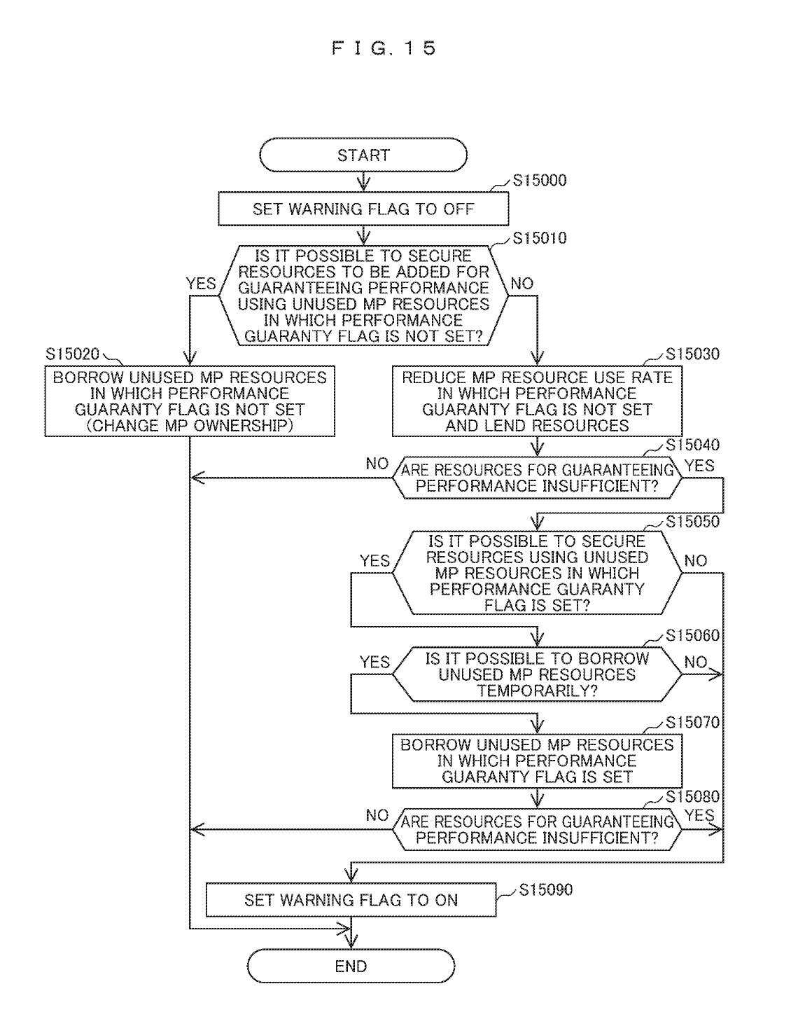

FIG. 15 is a diagram illustrating an example of a process flow of MP resource selection performed in S7100 of FIG. 7. This process flow is a part of the logical partition setting program 2060. As described above, in the MP resource arrangement, the MP can be used in another logical partition by switching the ownership of using the MP. The remaining process is the same as the process flow of the resource selection described above with reference to FIG. 8, and thus description thereof is omitted.

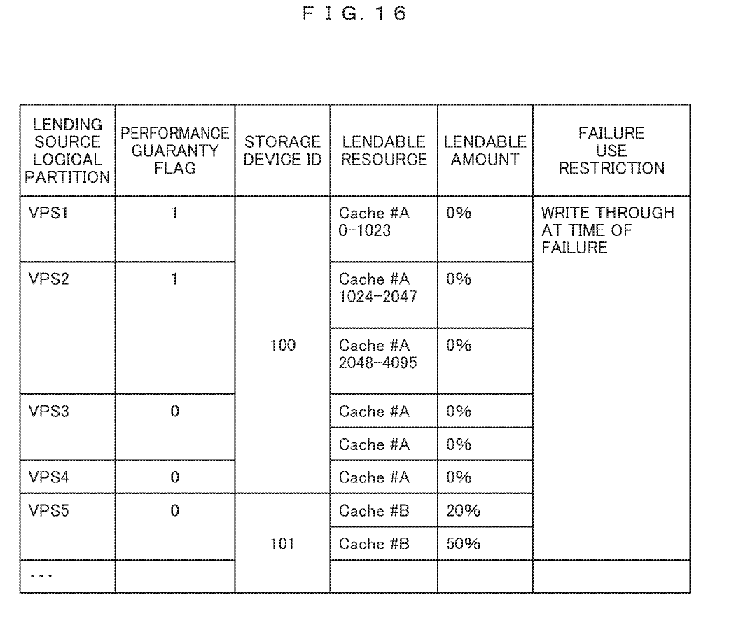

FIG. 16 is a diagram illustrating an example of the resource management information table of the cache memory 1221 allocated to each logical partition. The resource management information table of the cache memory 1221 is referred to in the logical partition setting program 2060. Since if a failure occurs in the cache memory 1221, and stored data is destroyed, it is difficult to recover the data, the cache memory 1221 is duplexed. Further, when a failure occurs in the cache memory 1221, only some regions of the cache memory 1221 are unable to be used in a few circumstances, and the whole of one plane of the cache memory 1221 is often unable to be used. Therefore, it is necessary to guarantee the performance in a state in which the whole of one plane of the cache memory 1221 which is duplexed and operates is unable to be used due to a failure.

Further, when the cache memory 1221 is not duplexed, there are cases in which a write through setting is performed in the cache memory 1221 so that the data stored in the cache memory 1221 is destroyed at the time of a failure, and data is written in the logical volume 1270 at the same time as when the data is written in the cache memory 1221. In this case, cache of one plane that is operating normally may be virtually converted into two planes and separated into a write through region and a read cache region. When sequential continuous data is read from the server, data is prefetched to the read cache, and thus the I/O performance of reading is improved.

Further, when there is a lendable region of the cache memory 1221 managed by another physical storage device 1200, cache resources of another physical storage device 1200 are borrowed and allocated. As a result, it can be used for a read cache or a remote copy buffer in addition to the region used for the write through, the I/O performance of reading and the remote copy can be expected to be improved.

In the resource management information table illustrated in FIG. 16, the calculated lendable amount of the cache resource is stored, but when data remains in the cache memory 1221, the destage occurs, and when the region of the destage is large, a time taken for the destage is increased accordingly, and thus there is a possibility that the performance deteriorates. In the case of a system in which the write through setting is not performed at the time of a failure, when unused regions of the cache resources are selected, the performance deterioration caused by the destage time is minimized, and thus the cache resource in which the lendable amount of the resource management information table is large, that is, the cache resource in which the use rate for the allocated cache amount is low is selected, and thus the destaged data mount is decreased.

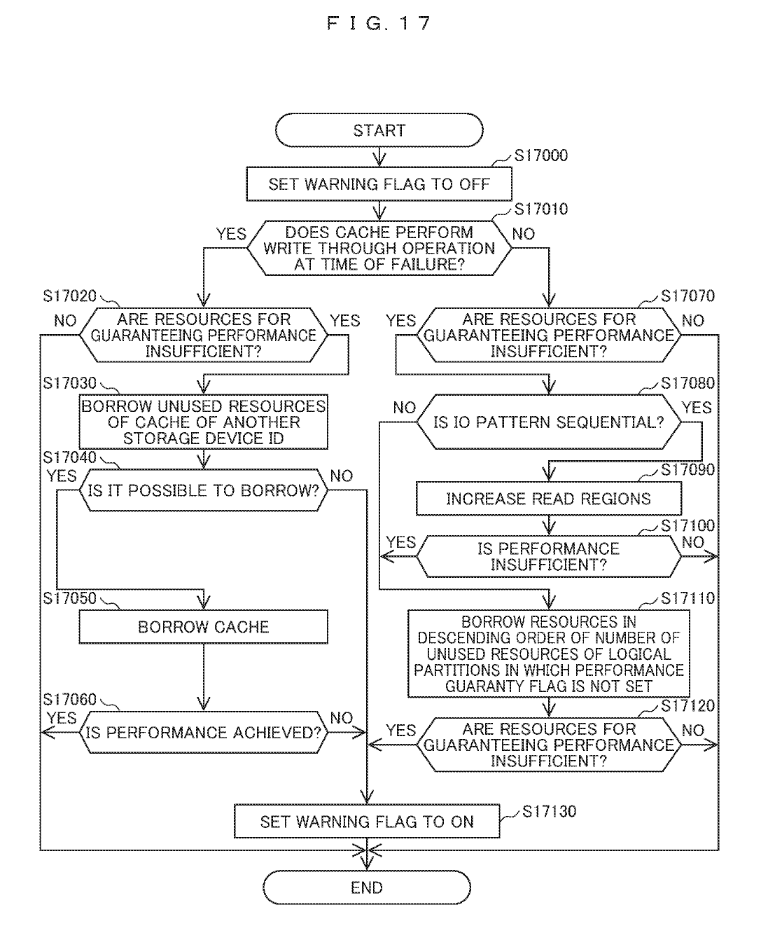

FIG. 17 is a diagram illustrating an example of a process flow of cache resource selection performed in S7100 of FIG. 7. This process flow is a part of the logical partition setting program 2060. The cache memory 1221 is a portion which is greatly influenced by a failure, and when the write through setting is performed, there is a possibility that the performance may decrease at one stretch, and thus the process flow of the resource selection illustrated in FIG. 17 is greatly changed from the process flow illustrated in FIG. 8.

First, the processor 2010 sets the warning flag to OFF (S17000), and determines whether or not a write through operation is performed in the cache memory 1221 at the time of a failure (S17010). When the write through operation is performed, the performance deterioration is unavoidable, but nevertheless, when the performance of the logical partition in which the performance guaranty flag is enabled is secured (NO in S17020), there is no problem in the device configuration itself, and thus the process ends.

To alleviate the performance degradation caused by the write through operations, the cache memory 1221 of another physical storage device 1200 may be used. When a plurality of physical storage devices 1200 are connected through a high availability cluster (HA cluster) configuration, there is a possibility that it is possible to use the cache memory 1221 of the physical storage device 1200 (S17030). Even in the case of a configuration other than the HA cluster configuration, when it is possible to share resources of another physical storage device 1200, the performance deterioration may be reduced by sharing the cache memory 1221 of the physical storage device 1200 in which no failure occurs.

However, if it is not such a system configuration (NO in S17040), the processor 2010 sets the warning flag to ON (S17130) and gives a notification indicating that it is difficult to guarantee the performance of the logical partition in which the performance guaranty flag is enabled to the administrator. When it is such a system configuration (YES in S17040), the processor 2010 performs the process of borrowing the cache resources (S17050), and when the performance of the logical partition in which the performance guaranty flag is enabled is not secured (NO in S17060), the warning flag is set to ON (S17130).

When the write through operation is not performed at the time of a failure (NO of S17010), but the cache resources are insufficient (YES in S17070), the processor 2010 checks the IO pattern (S17080). When the IO pattern is sequential (YES in S17080), an attempt to improve the read performance is made by increasing the resource amount of the read cache (S17090). Nevertheless, when the performance is insufficient (YES in S17100), there are cases in which the performance of the cache memory 1221 is high depending on the physical storage device 1200, and the performance is increased by increasing the cache resources, and thus the processor 2010 borrows the cache resources from the logical partition in which the performance guaranty flag is disabled in the descending order of the number of unused resources with reference to the resource management information table illustrated in FIG. 16 (S17110).

However, since it is unclear whether the IO performance will be improved reliably although the cache resources are increased, S17070 to S17110 may be omitted. When the cache resources for guaranteeing the performance are insufficient (YES in S17120), the processor 2010 sets the warning flag to ON (S17130).

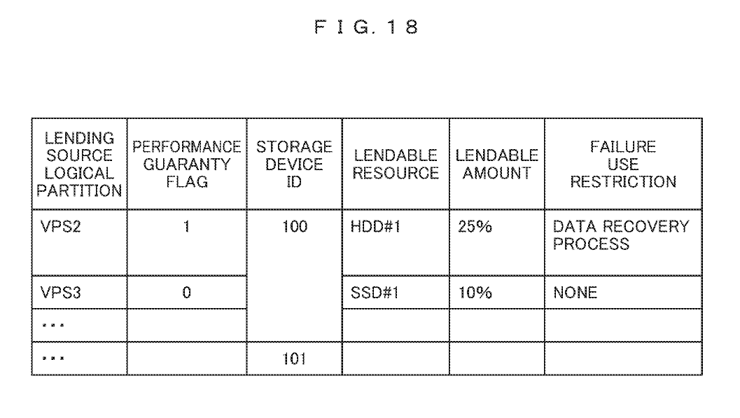

FIG. 18 illustrates the resource management information table of the disk drive 1250 allocated to each logical partition. The resource management information table includes the presence or absence of the performance guaranty flag set in each logical partition, the storage device ID, the lent resources (an HDD, an SSD, or the like), a lendable amount thereof, failure restriction information, and the like. In the physical storage device 1200, an RAID is configured with a plurality of disk drives 1250, whether or not data can be recovered at the time of a failure, a time taken until the recovery, and the like are decided according to the RAID configuration.

The resource selection processing is performed with reference to the resource management information table of this disk drive 1250. First, the disk resources are borrowed from the logical partition in which the performance guaranty flag is disabled, and the resource selection process is performed based on performance such as whether or not it is the inside of the same physical storage device 1200 or whether the type of the disk drive 1250 is an HDD or an SDD and the lendable amount.

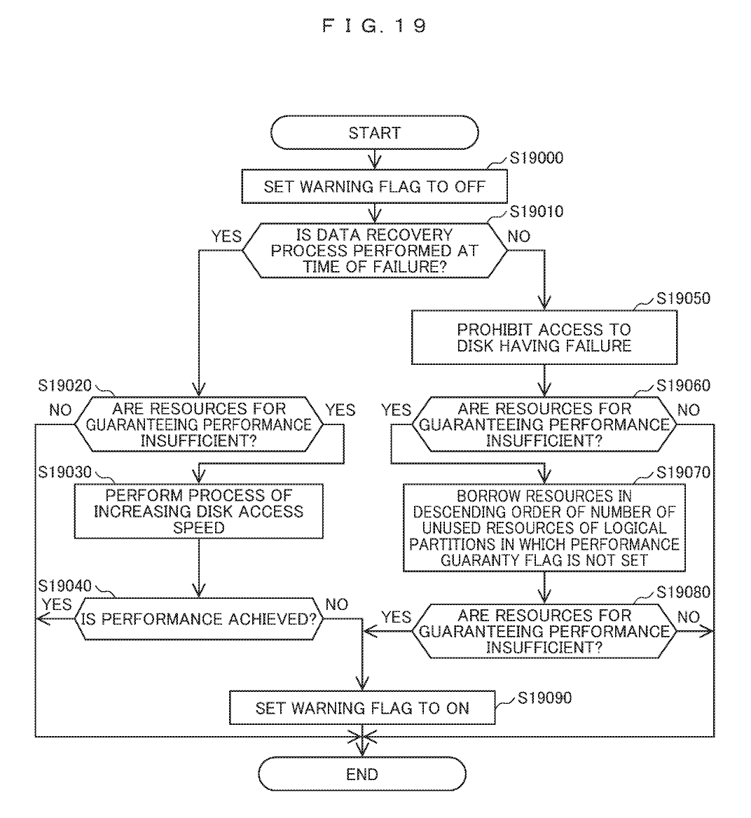

FIG. 19 is a diagram illustrating an example of a process flow of resource selection of disk drive 1250 performed in S7100 of FIG. 7. When a failure occurs in the disk drive 1250, a hardware restriction is large similarly to a failure in the cache memory 1221, and the process flow illustrated in FIG. 19 is a process flow which is greatly changed from the process flow described above with reference to FIG. 8. First, the processor 2010 sets the warning flag to OFF (S19000) and checks whether or not the data recovery process is performed at the time of a failure. When it is possible to guarantee the performance even during the data recovery process (NO in S19020), the resource selection process ends.

When the resources for guaranteeing the performance are insufficient (YES in S19020), the process of increasing the disk access speed is performed in order to make up for the performance deterioration caused by the data recovery (S19030). The speed increasing process is a process called dynamic provisioning, dynamic Tiering, or the like, and a speed of recovering data in which a failure has occurred, for example, a speed of migrating data to a high speed disk drive 1250 may be increased through data rearrangement.

Since data is destroyed when there is no data recovery process (NO in S19010), the processor 2010 performs a process of prohibiting access to the disk drive 1250 in which a failure has occurred (S19050). When resources are insufficient (YES in S19060), the process of borrowing resources from the logical partition in which the performance guaranty flag is disabled in the descending order of the number of unused resources (S19070). When the resources for guaranteeing performance are not allocated to the logical partition in which the performance guaranty flag is enabled (YES in S19080), the processor 2010 sets the warning flag to ON (S19090) and warns the administrator about it.

As described above, according to the present embodiment, the logical partition that should guarantee the performance when a failure occurs borrows resources from logical partition that does not guarantee the performance, and thus the performance of the logical partition that should guarantee performance can be guaranteed. Further, resources can be borrowed between the logical partitions that should guarantee performance.

In the present embodiment, the example in which the resources are lent and borrowed when a failure is detected by the logical partition setting program 2060 has been described, but this process may be performed in the physical storage device 1200. Further, the process may be performed according to an instruction of the user rather than the failure detection, or the process may be performed when a data failure or a database abnormality is detected through virus detection.

Further, when there are unallocated resources from the beginning, the logical partition in which resources are insufficient may be allowed to preferentially borrow unallocated resources, and borrowing of resources may be performed between the logical partitions when there are no unallocated resources that can be borrowed.

### Second Embodiment

In the first embodiment, the upper limit of the resources necessary for the IO performance (IOPS) is set in advance, and the process of lending and borrowing the resources is performed at the time of a failure. On the other hand, in the second embodiment, the management server 2000 monitors an actual IO amount, detects a situation in which the IOPS does not satisfy the performance requirement, and guarantees the performance by lending and borrowing the resources based on the monitored IO amount. Many portions in the second embodiment have the same configuration as those in the first embodiment, and thus description will proceed with different configurations.

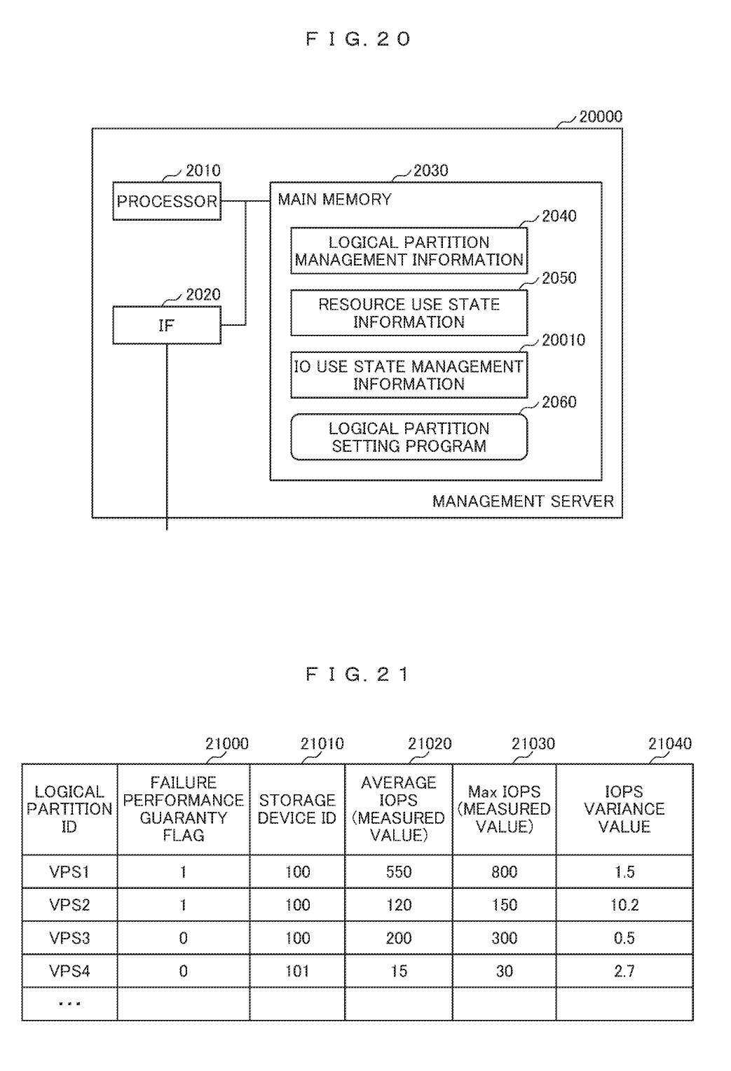

FIG. 20 is a diagram illustrating an example of a configuration of a management server 20000. Compared to the management server 2000 illustrated in FIG. 2, the management server 20000 monitors an IO use state and further includes IO use state management information 20010 for managing information about the IO use state.

FIG. 21 is a diagram illustrating an example of table management information of the IO use state management information 20010. The IOPS of each logical partition is measured, and in the table management information of IO use state management information 20010, an average IOPS 21020 and Max IOPS 21030 of a measurement result are managed in a table form. For this management, the table management information may include a performance guaranty flag 21000 and a storage device ID 21010. The average IOPS 21020 indicates a degree in which the IOPS performance is secured during a normal operation. The Max IOPS 21030 indicates a desirable degree in which the performance is guaranteed when an IO access load is increased. Further, when an average value and a variance value 21040 of the IOPS or a standard deviation are calculated and managed, it is possible to indicate a deviation in which the IO access is performed and the tendency of the resource use rate at that time.

Thus, it is possible to detect a timing at which the performance deterioration starts, and it is also possible to guarantee resources to the logical partition in advance and guarantee the performance. As a tendency of a relation between the IOPS and the used resource amount, for example, when the variance is small, it indicates that it is possible to secure the performance by the average amount of the resources which are currently allocated. In this case, the used resource amount at that time is employed as the upper limit of the resource securing upper limit management table of FIG. 5.

Further, when the variation is large, it is possible to secure resources that should be secured by monitoring the used resource amount at that time while securing the average amount. When it is possible to specify resources that should be secured, the logical partition may secure and maintain even resources that are high in the non-use rate at a certain timing without releasing the resources.

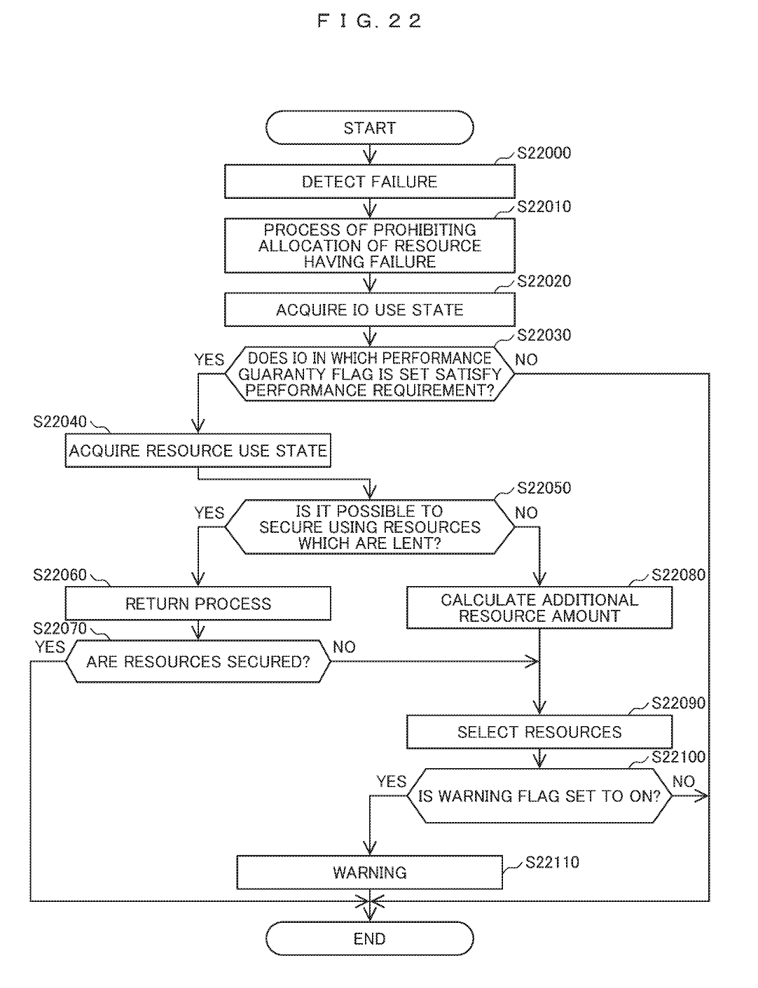

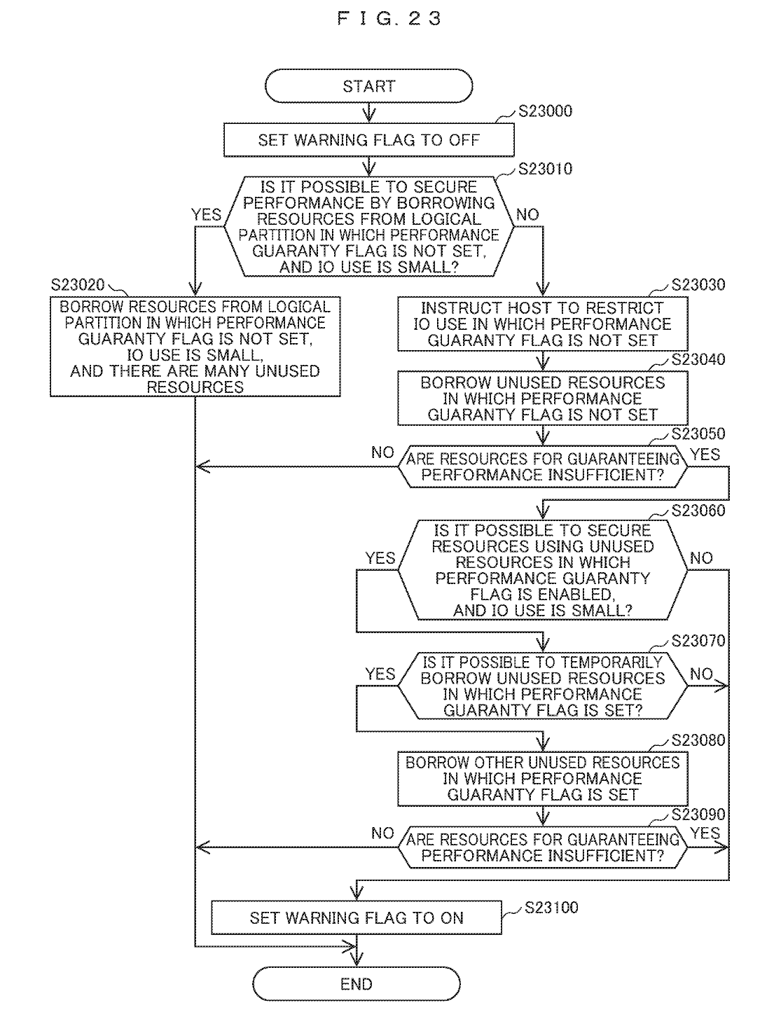

FIG. 22 is a diagram illustrating an example of a process flow of a resource rearrangement setting at the time of a failure corresponding to FIG. 7 of the first embodiment. When a failure occurs, the processor 2010 detects the failure (S22000), and prohibits allocation of resources in which the failure has occurred (S22010). Then, the processor 2010 monitors the IO use state (S22020), and checks whether or not the IO performance satisfies the performance requirement (S22030). The processor 2010 acquires the resource use state when the IO performance is insufficient (S22040). The other processes (S22050 to S22080 and S22100 to S22110) except for the resource selection (S22090) are the same as in the process flow already described with reference to FIG. 7, and thus description thereof is omitted. The resource selection (S22090) will be described later with reference to FIG. 23.

A difference with the first embodiment lies in that the processor 2010 does not determine whether or not the resource securing upper limit value is exceeded with reference to the table illustrated in FIG. 5, and the processor 2010 monitors the IO performance and secures resources according to whether or not the IO performance satisfies the performance requirement. Since the actual IO performance is monitored, the purpose of guaranteeing the IO performance is directly achieved. The tendency of the IO performance to be guaranteed may be calculated using the average IOPS 21020 and the Max IOPS 21030, and resources for securing the IO performance may be rearranged in advance.

Further, it is possible to monitor the 10 performance of the logical partition which lends the resource and acquire the performance before the resources are rearranged and the performance deteriorated after the resources are arranged. Thus, the performance deterioration amount may be restricted in the logical partition in which the performance guaranty flag is disabled in addition to the logical partition in which performance guaranty flag is enabled.

FIG. 23 is a diagram illustrating an example of a process flow of resource selection. The resource selection is the process of S22090 of FIG. 22. Basically, this process flow is basically the same as the process flow described above with reference to FIG. 9 in the first embodiment, but a difference lies in that a destination to which resources are borrowed is selected based on the unused resource amount, and resources are borrowed from the logical partition which is low in the 10 use rate based on the 10 use state (S23010). This is based on the assumption that when the use of the 10 is low, it indicates that few allocated resources are used, that is, there are many unused resources.

When resources are borrowed from the logical partition that heavily uses the IO, the performance is likely to abruptly deteriorate although the performance guaranty flag is disabled. In the case of a system that is on the premise of a cloud environment and convenient for all users to use, since claims from the user are small when the abrupt performance deterioration is avoided, resources are borrowed from the logical partition in which the IO is less used.

Further, since IO use state is monitored, the IO use rate may be predicted in advance based on the IO use trend, and when the IO performance of the logical partition in which the performance guaranty flag is enabled starts to run short, an instruction to suppress the IO use is given to the host computer 1000 which is using the logical partition in which the performance guaranty flag is disabled in advance (S23030) As a result, a lot of unused resources of the logical partition in which the performance guaranty flag is disabled are secured, and thus many resources may be allocated to the logical partition in which the performance guaranty flag is enabled. The other processes of the process flow illustrated in FIG. 23 are the same as those in the process flow described above with reference to FIG. 8, and thus description thereof is omitted.

As described above, according to the second embodiment, the logical partition that should guarantee the performance when a failure occurs borrows resources from the logical partition that does not guarantee the performance, and thus it is possible to guarantee the performance of the logical partition that should guarantee the performance. Particularly, since the performance is measured and guaranteed, it is possible to guarantee the accurate performance.

### REFERENCE SIGNS LIST

1000 host computer
1200 storage device
1210 FE PK
1220 CM PK
1230 MP PK
1240 BE PK
1250 disk drive
1270 logical volume
1500 logical partition
2000 management server

1. A computer system, comprising:
a host computer;
a storage device; and
a management computer,
wherein the storage device includes
a port that is connected with the host computer,
a cache memory,
a processor, and
a plurality of logical volumes which are logical storage regions,
the port, the cache memory, and the processor are divided into logical partitions as resources used for reading and writing of the logical volume for each logical volume,
the host computer performs reading and writing on the logical volumes, and
the management computer gives an instruction to the storage device so that resources of the logical partition in which performance of reading and writing is not guaranteed are allocated to the logical partition in which the performance of the reading and writing is guaranteed when a failure occurs in the storage device.

2. The computer system according to claim 1,
wherein the management computer
includes first information identifying the logical partition in which the performance of the reading and writing is not guaranteed and the logical partition in which the performance of the reading and writing is guaranteed, and
gives an instruction to the storage device so that the resources of the logical partition in which performance of reading and writing is not guaranteed are allocated to the logical partition in which the performance of the reading and writing is guaranteed based on the first information.

3. The computer system according to claim 2,
wherein the management computer
does not give the instruction when a failure occurs in the resources of the logical partition in which the performance of the reading and writing is not guaranteed, and
gives the instruction when a failure occurs in resources of the logical partition in which the performance of the reading and writing is guaranteed, and

4. The computer system according to claim 3,
wherein the management computer
includes second information indicating a relation between a use amount of resources in units of the logical partition and the performance of the reading and writing in units of the logical partitions,
allocates initial resources of the logical partition in which the reading and writing is guaranteed based on the second information and the guaranteed performance of the reading and writing, and
gives an instruction to the storage device so that an insufficient amount of resources which are not usable due to the occurred failure are allocated from the logical partition in which the performance of the reading and writing is not guaranteed to the logical partition in which the performance of the reading and writing is guaranteed.

5. The computer system according to claim 4,
wherein the management computer gives an instruction to the storage device so that unused resources of the logical partition in which the performance of the reading and writing is not guaranteed are allocated to the logical partition in which the performance of the reading and writing is guaranteed.

6. The computer system according to claim 5,
wherein when an amount of the unused resources of the logical partition in which the performance of the reading and writing is not guaranteed is smaller than the insufficient amount of the resources,
the management computer gives an instruction to the storage device so that the amount of the unused resources is increased by decreasing the use amount of the resources of the logical partition in which the performance of the reading and writing is not guaranteed, and the unused resources are allocated to the logical partition in which the performance of the reading and writing is guaranteed.

7. The computer system according to claim 6,
wherein when a failure occurs in a port of the logical partition in which the performance of the reading and writing is guaranteed,
the management computer determines whether multiple paths are established between the host computer and the storage device; and establishes the multiple paths when the multiple paths are determined not to be established between the host computer and the storage device.

8. The computer system according to claim 6,
wherein the storage device includes a first cache memory and a second cache memory which are duplexed, and
when a failure occurs in the first cache memory including cache data of the logical partition in which the performance of the reading and writing is guaranteed,
the management computer gives an instruction to the storage device so that a different cache memory is allocated as resources depending on whether or not the second cache memory performs a write through operation.

9. The computer system according to claim 6,
wherein when a failure occurs in a processor of the logical partition in which the performance of the reading and writing is guaranteed,
the management computer gives an instruction to the storage device so that a processor of the logical partition in which the performance of the reading and writing is not guaranteed to the logical partition in which the performance of the reading and writing in units of processors.

10. The computer system according to claim 1,
wherein when a failure occurs in the storage device,
the management computer acquires performance of the logical partition in which the performance of the reading and writing is guaranteed, and gives an instruction to the storage device so that resources of the logical partition in which the performance of the reading and writing is not guaranteed are allocated to the logical partition in which the performance of the reading and writing is guaranteed when the acquired performance is lower than performance to be guaranteed.

11. The computer system according to claim 10,
wherein a plurality of logical partitions in which the performance of the reading and writing is not guaranteed,
the management computer gives an instruction to the storage device so that resources of the logical partition which is smallest in the reading and writing of the logical volume among the plurality of logical partitions in which the performance of the reading and writing is not guaranteed are allocated to the logical partition in which the performance of the reading and writing is guaranteed.

12. The computer system according to claim 11,
wherein the management computer gives an instruction to restrict the reading and writing on the host computer which performs the reading and writing on the logical volume belonging to the logical partition in which the performance of reading and writing is not guaranteed

13. A storage device connected to a host computer, comprising:
a port that is connected with the host computer,
a cache memory,
a processor, and
a plurality of logical volumes which are logical storage regions,
the port, the cache memory, and the processor are divided into logical partitions as resources used for reading and writing of the logical volume for each logical volume, and
resources of the logical partition in which performance of reading and writing is not guaranteed are allocated to the logical partition in which the performance of the reading and writing is guaranteed when a failure occurs in the storage device.

14. The storage device according to claim 13,
wherein information identifying the logical partition in which the performance of the reading and writing is not guaranteed and the logical partition in which the performance of the reading and writing is guaranteed is provided, and
the resources of the logical partition in which performance of reading and writing is not guaranteed are allocated to the logical partition in which the performance of the reading and writing is guaranteed based on the information.

15. The storage device according to claim 14,
wherein when a failure occurs in the resources of the logical partition in which the performance of the reading and writing is not guaranteed, the allocation is performed, and
when a failure occurs in resources of the logical partition in which the performance of the reading and writing is guaranteed, the allocation is not performed.
